(19) United States
(12) Patent Application Publication
(10) Pub. No.: US 2013/0185131 A1
(43) Pub. Date: Jul. 18, 2013

(54) SYSTEM AND METHOD FOR INTEGRATING SOCIAL AND LOYALTY PLATFORMS

(71) Applicants: Pradeep Sinha, Medina, MN (US); Devdatta Halbe, Eden Prairie, MN (US)

(72) Inventors: Pradeep Sinha, Medina, MN (US); Devdatta Halbe, Eden Prairie, MN (US)

(21) Appl. No.: 13/552,469

(22) Filed: Jul. 18, 2012

Related U.S. Application Data
(60) Provisional application No. 61/508,870, filed on Jul. 18, 2011.

(51) Int. Cl. G06Q 30/02; G06Q 50/00

(52) U.S. Cl. CPC G06Q 30/0226; G06Q 50/01
USPC 705/14.27

(57) ABSTRACT

A method may to authorize a loyalty integration service with a social platform may include transmitting an authorization screen to a user terminal. The authorization screen may include a request to grant a loyalty integration service (LIS) user application access to an identifier of a user on a social platform. The method may further comprise receiving authorization from the user indicating the LIS user application can access the identifier of the user. Then, based on receiving the authorization, the identification of the user on the social platform may be linked with a member identifier associated with the user on a loyalty program. Further, on the user terminal, a dashboard to the user may be presented within the LIS user application. The dashboard may include offers customized for the user based on the user's social data in the social network and loyalty data in the loyalty program.

### CROSS-RELATED APPLICATIONS

This patent application claims the benefit of priority, under 35 U.S.C. §119(e), to U.S. Provisional Patent Application Ser. No. 61/508,870 titled “SYSTEM AND METHOD FOR INTEGRATING SOCIAL AND LOYALTY PLATFORMS,” filed on Jul. 18, 2011, which is incorporated by reference in its entirety

### BACKGROUND

Organizations frequently sponsor loyalty or other points based programs to track and reward activities of employees, customers, and other constituents. Additionally, many of these same constituents have accounts on one or more social networking platforms.

### SUMMARY

Organizations (e.g., stores, companies, non-profits, trade groups, fan clubs, etc.) frequently sponsor loyalty or other points based programs (collectively referred to as loyalty programs or platforms) to track and reward activities of employees, customers, and other constituents of the organization (collectively referred to as members). The members may be identified in the loyalty program by a membership number for the program. The members may also have users accounts with one or more social networking platforms. Additionally, the organizations may have a presence (e.g., an account or webpage) on the one or more social networking platforms.

A problem currently exists in integrating the account of the user on the social networking platform with one or more of the user's loyalty program accounts. For example, consider the situation when a user, who has an account with a social networking platform and is a member of an organization's loyalty program, visits the organization's presence on the social networking platform. Without knowing that the user is a member of the organization's loyalty program, the information presented to the user may not be different than a user who visits the organization's presence who is not a member of the organizations loyalty program.

In various embodiments, system and methods are used to link a user's social networking identity with the user's membership identity of a loyalty program. To facilitate this linking, a loyalty integration service (LIS) may be used. In an embodiment, the program sponsor (e.g., the organization running the loyalty program) grants permission to the LIS to run code (e.g., an application) on the program sponsor's account page on a social networking platform. Additionally, the user may grant permission to the LIS to install code (e.g., an application) on the user's profile of the social media platform. Thus, there may be two types of applications that communicate with the LIS, a LIS sponsor application and a LIS User Application, respectively.

In various embodiments, through use of the applications, a user may access special campaigns targeted towards users on the social media platforms and the sponsor may utilize social information for more targeted offers. Additionally, users of the social media platform, by connecting the user application to different loyalty program providers, may access all of their loyalty information in one place. Other uses of the LIS and accompanying applications are described below.

### BRIEF DESCRIPTION OF DRAWINGS

Some embodiments are illustrated by way of example and not limitation in the figures of the accompanying drawings in which:

FIG. 1 is an overview diagram of a system, according to example embodiment.

FIG. 2 is a data flow diagram, according to an example embodiment.

FIGS. 3-7 are user interfaces, according to various example embodiments

FIG. 8 is a data flow diagram, according to an example embodiment.

FIG. 9 is a block diagram, according to an example embodiment.

FIG. 10 is a block diagram of machine in the example form of a computer system within which a set instructions, for causing the machine to perform any one or more of the methodologies discussed herein, may be executed.

FIGS. 11-12 are user interfaces, according to example embodiments.

FIG. 13 is a graph of a social network, according to an example embodiment.

FIG. 14 is a user interface, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

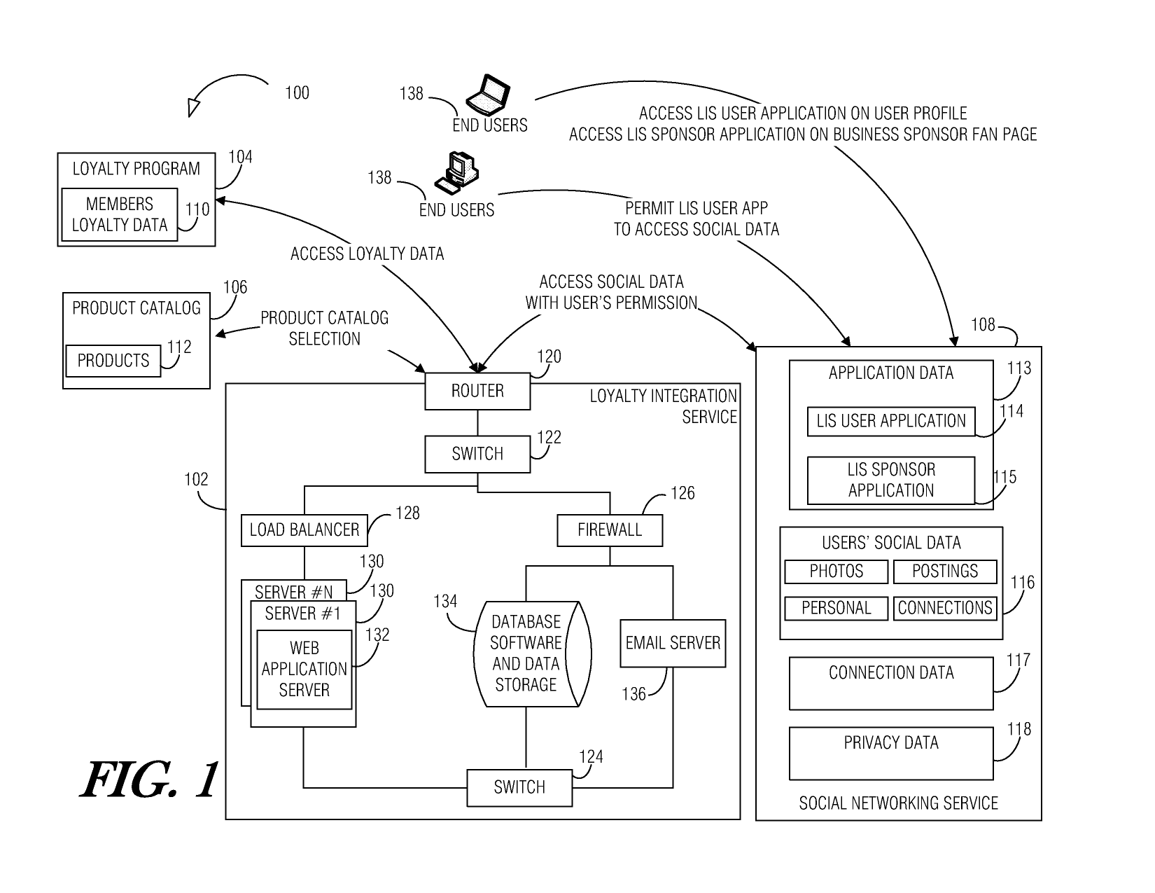

FIG. 1 is an overview diagram of system 100. Illustrated is Loyalty Integration Service 102, Loyalty Platform 104, Product Catalog 106, Social Networking Service 108 (also referred to as a platform), and End Users 138. Loyalty platform 104 is shown with member's loyalty data 110. Product catalog 106 is illustrated with products 112. Social Networking Service 108 includes Application Data 113, LIS User Application 114, LIS Sponsor Application 115, and Users' Social Data 116, Connection Data 117, and Privacy Data 118. Loyalty integration service 102 includes router 120, switches 122 and 124, firewall 126, load balancer 128, servers 130, web server 132, database software and data storage 134, and e-mail server 136. While Loyalty Platform 104, product catalog 106, and Social Networking Service 108 are shown as single instances, various embodiments may include one or more loyalty platforms, product catalogs, and Social Networking Services.

In an embodiment, end users 138, loyalty platform 104, product catalog 106, loyalty integration service 102, and Social Networking Service 108 communicate through a network. The network may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network may include a single local area network (LAN) or wide-area network (WAN), or combinations of LAN's or WAN's, such as the Internet. The various devices, platforms, and users coupled to the network may be coupled to the network via one or more wired or wireless connections.

In an embodiment, Social Networking Service 108 is an online service, platform or site that allows its users to build or reflect social networks or social relations among users (e.g., FACEBOOK). The Social Networking Service may store social data for each of its user in one or more databases. The social data may include photos, postings, personal information, and a listing of connections the user has made with other users, applications, or business pages.

In various embodiments, users construct profiles on a Social Networking Service which include personal and demographic information such as name, contact information, employment information, photographs, personal messages, status information, links to web-related content, blogs, and so on. Typically, only a portion of a user's profile may be viewed by the general public, and/or other users. A user may post a social media message (illustrated as postings in FIG. 1) on his or her profile page. A posting may include links to websites, photos, videos, etc.

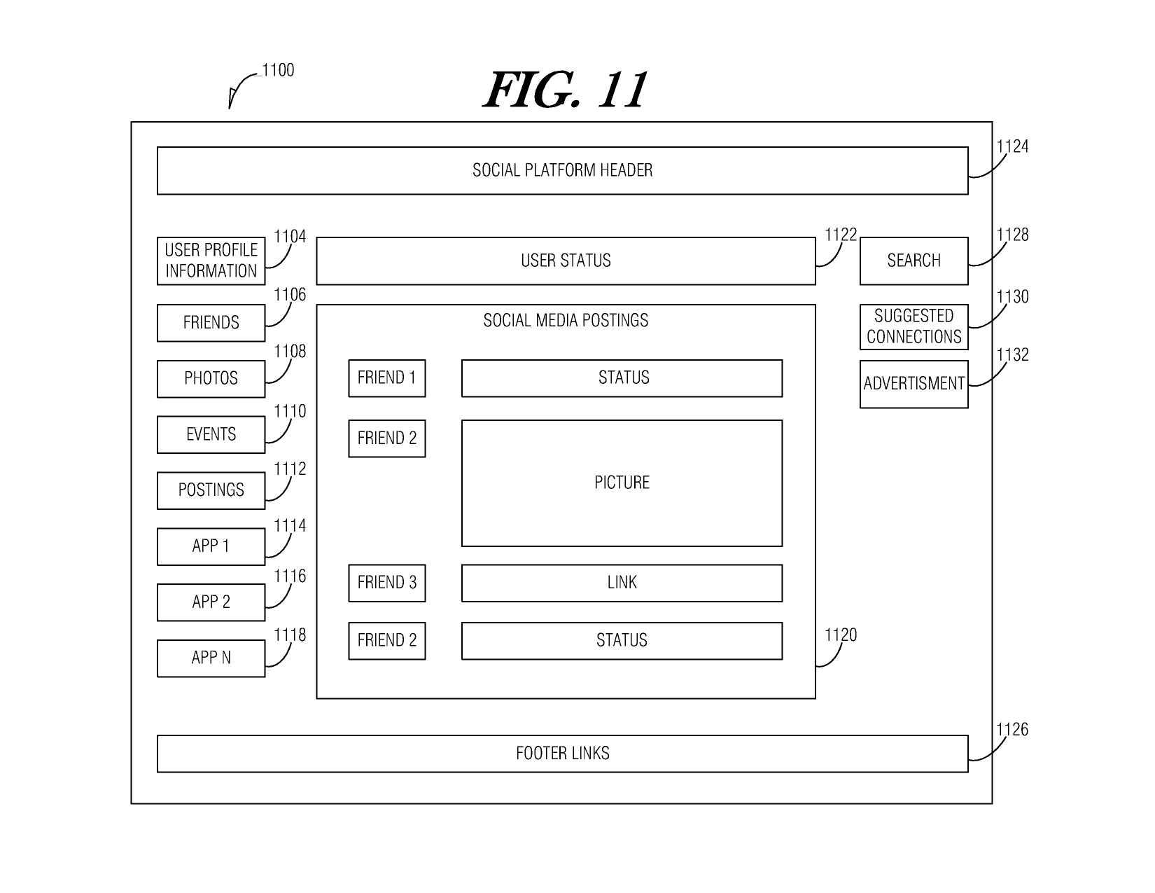

FIG. 11 is an example user interface 1100 that may be presented to a user upon logging into Social Networking Service 108. The user interface may be presented in a web browser, stand alone application, or on a mobile device. Illustrated are links to user profile information 1104, friends 1106, photos 1108, events 1110, postings 1112, app 1 1114, app 2 1116, and app N. In various embodiments links 1104-1112 may also be considered links to applications. Also illustrated is an input box 1122 for the user to enter his or her status (e.g., a social media message). The status may include text, links, photos, and videos.

Further illustrated is a user interface portion for social media postings 1120 by friends of the user. Social media postings of the user may also appear in social media postings 1120. Social platform header 1124 and footer links 1126 may also appear on user interface 1100. Search box 1128 may be provide an input box from which the user searches Social Networking Service 108 for other users, events, photos, applications, etc. Suggested connections 1130 may list other users or applications the user may wish to form a connection with. Advertisements 1132 may be show to users.

In various embodiments, Social Networking Service 108 allows users to identify, and establish links or connections with other users in order to build or reflect social networks or social relations among users. For instance, in the context of a personal Social Networking Service, a person may establish a link or connection with his or her friends, family, etc. Social Media Postings 1120 may be limited to the user's with which the user has formed connections with. Friends link 1106 may bring the user to a user interface that lists all of the connections made by the user. In various embodiments throughout “friends” of the user refers to the collective connections made by the user to other users.

A connection is generally formed using an invitation process in which one user “invites” a second user to form a link. The second member than has the option of accepting or declining the invitation. In an embodiment, a social networking site allows businesses to have a profile with which users may form connections. In general, a connection or link represents or is otherwise associated with an information access privilege, such that a first person who has established a connection with a second person is, via the establishment of that connection, authorizing the second person to view or access non-publicly available portions of the person's profile. In an embodiment, Social Networking Service 108 stores data representing the connections between users, business presences, and applications in Connection Data 117.

In various embodiments, the nature and type of information that may be shared, as well as the granularity of access privileges may be defined to protect certain types of data. The user may decide on a per connection basis which information of the user is acceptable via each connection. For example, a user may share pictures with the user's friends, but not with businesses. In various embodiments, data representing the access privileges set by the user for each connection are stored as privacy data 118 in one or more databases.

Users of Social Networking Service 108 may also install applications on their profiles such as LIS User Application 114. Installing may include accepting a user agreement from the application provider. In an embodiment, an installed application appears as a link on the user's profile. Upon clicking on the link for the application, a user interface may be presented to the user associated with the application. For example, event link 1110 may present the user with a list of event initiations that have been sent to the user. In various embodiments, certain user interface elements of user interface 1100 may be maintained across all applications. For example, social platform header 1124 and footer links 1126 may be presented so that a user knows he or she is still on Social Networking Service 108.

In various embodiments, applications may access data that is not stored on the Social Networking Service. For example, LIS User Application 114 and LIS sponsor application 115 may communicate with loyalty integration service 102. Through the use of the information available to the application, services may be provided to the user as will be discussed in more detail herein.

In an embodiment, an application is hosted on Social Networking Service 108. In an alternative embodiment, an application is hosted on a server external to Social Networking Service 108. Although the hosting location of the application may vary, the appearance of the application to the user may not change. In other words, the user may not be able to tell where an application is hosted. Thus, in various embodiments, a user interface on Social Networking Service 108 may include elements from an application that is hosted on third-party servers.

With respect to FIG. 1, Social Networking Service may store data representing certain applications in application data 113. This data may include an internet address of where the application is hosted. In an embodiment illustrated in FIG. 1, application data 113 may include an address of LIS 102. Accordingly, user interactions with elements of LIS User Application 114 may be encoded and transmitted to LIS 102 for processing. LIS 102 in turn may transmit updates to Social Networking Service 108 on how to update the user interface being presented to the user.

As with connections to other users, the installation of an application on a user profile may grant certain permissions to the application allowing the application to access some or all of the user's social data information that is not publicly available about the user. In other words, a connection may be formed between a user and an application. Similarly, a business profile/presence on Social Networking Service 108 may install an application (e.g., LIS sponsor application 115) which grants the application permission to use information about the business that may not be publicly available. In various embodiments, data representing the access privileges granted to each application are stored as privacy data 118 in one or more databases.

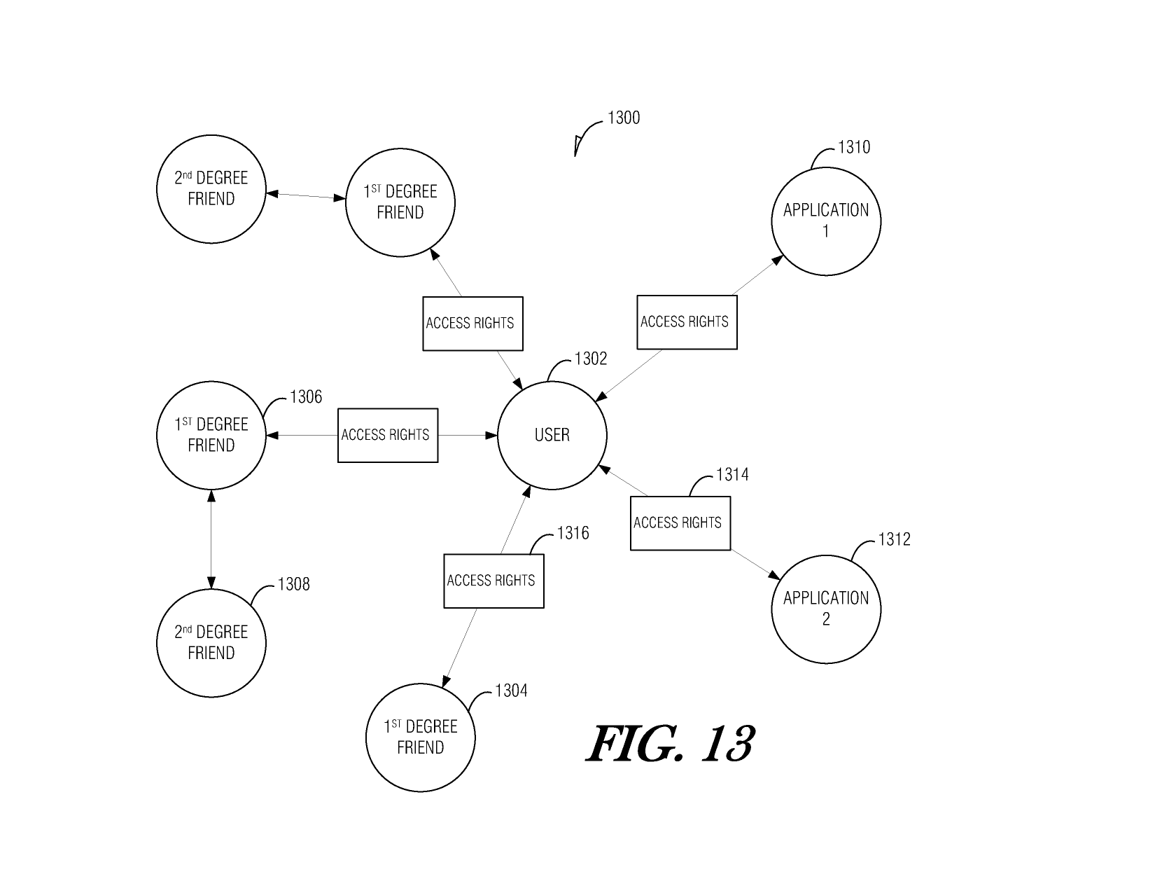

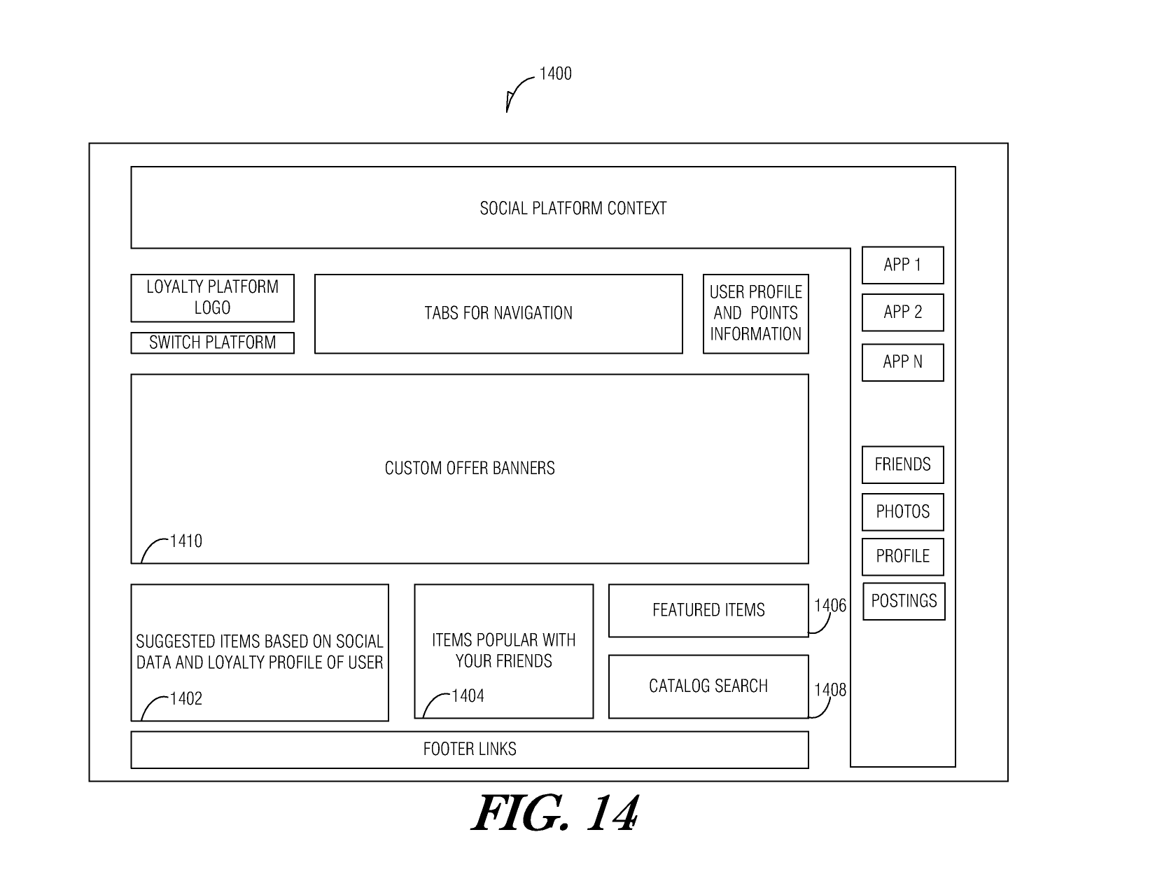

FIG. 13 is a symbolic representation of a user's social graph 1300. In an embodiment, entities within a social network may be represented as a graph with each edge being a connection and each user or application being a node. Illustrated is user node 1302, 1st degree friend nodes 1304, 1306, 2nd degree friend node 1308, application 1, 1310, application 2, 1312, and access rights 1314, 1316.

Graph 1300 is represented from the point of view of a single user and the connections made by that user. For example, user node 1302 is connected directly to 1st degree friends nodes 1304 and 1306 indicating that the user has granted access rights to the users represented by friend nodes 1304 and 1306. User node 1302 is indirectly connected to 2nd degree friend node 1308. In other words, 1st degree friend node 1306 has granted access rights to 2nd degree friend node 1308. 2nd degree friends may also be considered friends of friends.

In various embodiments, the user may be able to see a portion of social data of indirectly connected friends. For example, the user might be able to see the name of the user associated with 2nd degree friend node 1308. A user may set a preference that is stored on the social platform that represents how much data is available to indirectly connected friends. For example, the user may decide that all photos will be available to friends of friends. Similarly, the user may decide that no social data is to be made available to anyone except 1st degree friends. As with other access rights data, these preferences may be stored in one or more databases of a social networking service (e.g., in privacy data 118 of FIG. 1).

End users 138 may communicate with Social Networking Service 108 through the use of one or more user terminals. A user terminal may be a personal computer, mobile device, or other device capable of networking indication. In an embodiment, a user terminal includes a client program (e.g., Internet browser) to interface with Social Networking Service 108. The client program may include commercial software, custom software, open source software, freeware, shareware, or other types of software packages. The client program may also interact with loyalty integration service 102.

In an embodiment, loyalty platform 104 represents a loyalty program. Loyalty programs track and reward activities of its members with loyalty points. For example, consider a restaurant based loyalty program for restaurant ABC. When a member of the loyalty program for restaurant ABC visits one of ABC's locations the loyalty program may give the member 100 points. These points may be redeemed, for example, as coupons for the restaurant or other goods or services. In this manner, members of the loyalty program are rewarded with gifts which encouraged the member to go back to the restaurant. The term points is intended to be exemplary in nature and other forms of monetary currency or non-monetary currency may be utilized in a loyalty program (e.g., credits).

Loyalty program 104 may store information about its members in members loyalty data 110. This data may be stored in one or more databases, for example. Members loyalty data 110 may include, but is not limited to, contact information, transaction information, and point total information for the members of the loyalty program.

Product catalog 106 may store information on products 112 that may be purchased using points provided by a loyalty platform (e.g., FACEBOOK credits). For example products 112 may include digital media products such as songs video or e-books, tangible goods, or virtual goods (e.g., items in online games).

Loyalty integration service 102 is shown with components that enable data communication between the loyalty platforms, product catalogs, and Social Networking Services. Data may enter the loyalty integration service using router 120 where the data may be routed using switches 122, 124, to the appropriate component. While illustrated as only one router and two switches more or fewer routers and switches may be used. Similarly there may be multiple load balancers, firewalls, e-mail servers, databases, and web application servers. Additionally, the components may be located in different geographical regions. For example, there may be one set of servers dedicated to handle the East Coast while another set of servers handles network traffic on the West Coast.

Web application server 132 may communicate with a file server to publish or serve files stored in database 134. Web application server 132 may also enable web-based presentation of information to administrators of various loyalty platforms as well as users of Social Networking Services. For example, web application server 132 may consist of scripts, applications, or library files that provide multimedia, file transfer, or dynamic interface functions. In addition, web application server 132 may provide an interface to communicate with one or more of the other components in system 100. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™)

Database software and data storage 134 may be composed of one or more logical or physical databases. For example, database software and data storage 134 may be viewed as a system of databases that when viewed as a compilation, represent an “operations database.” Sub-databases in such a configuration may include a loyalty information database, user information database, offer information database, and a report database. Database software and data storage 134 may be implemented as a relational database, a centralized database, a distributed database, an object oriented database, or a flat database in various embodiments.

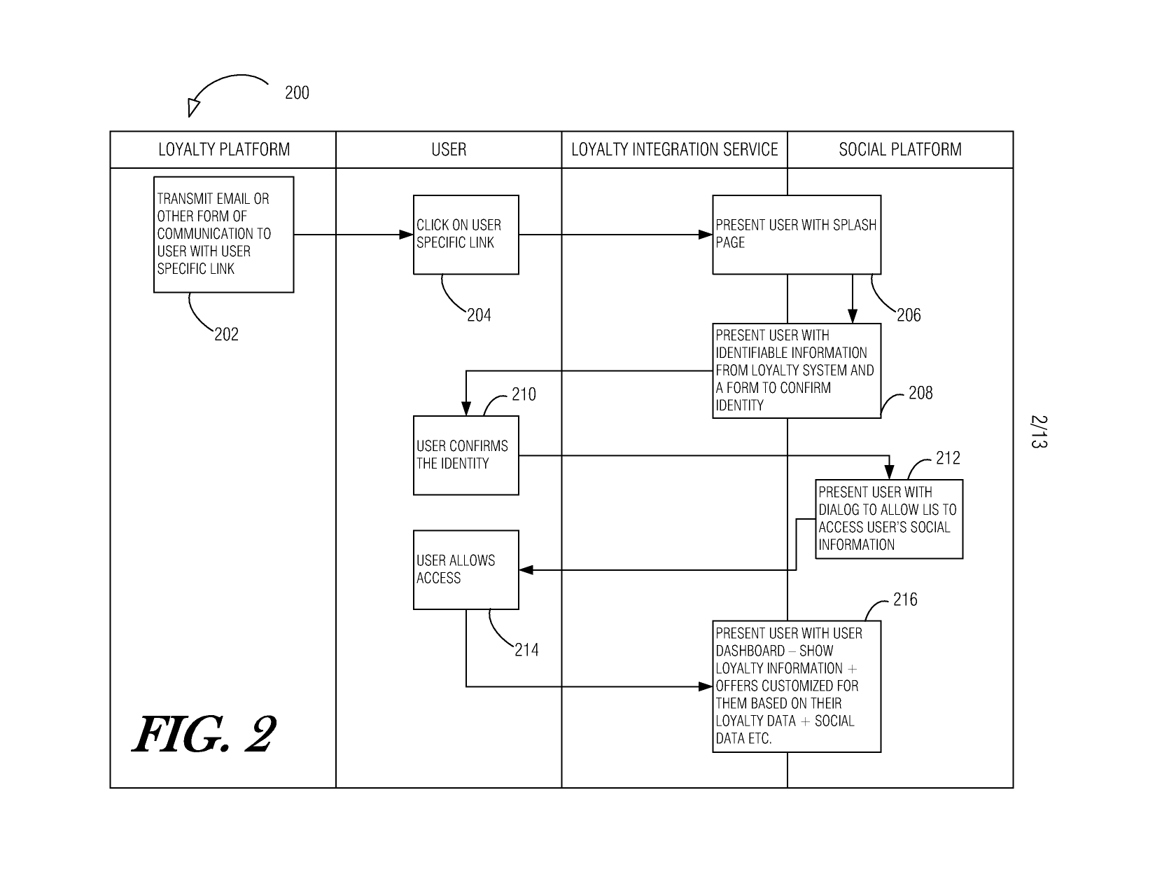

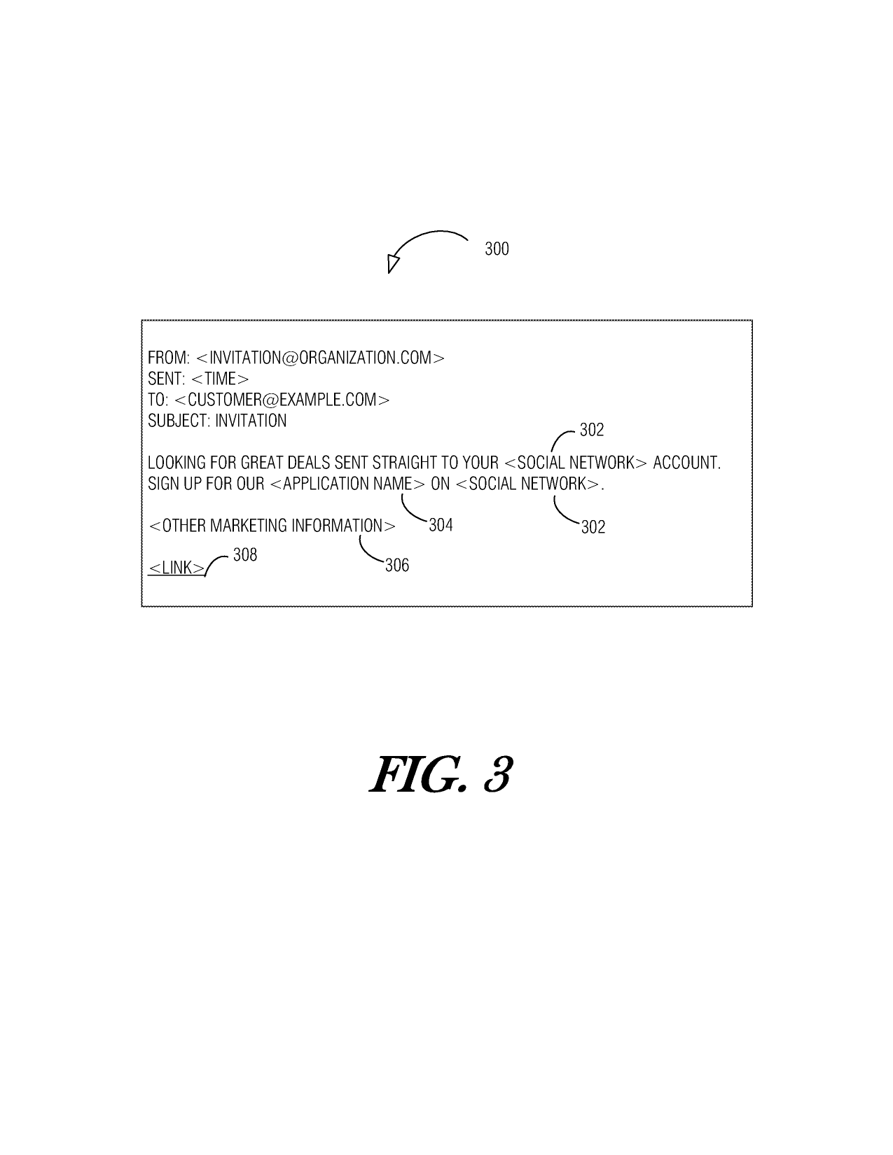

FIG. 2 is a data flow diagram illustrating interactions between a loyalty platform, a user, a loyalty integration service, and a social platform. At block 202 an email or other form of communication (e.g., SMS message, instance message, social media posting) is transmitted to a user with a user specific link. For example, FIG. 3 is an example e-mail 300 that may be transmitted to a user. In an embodiment, the e-mail is sent from the loyalty program (illustrated as organization in FIG. 3) to existing members (illustrated as customer in FIG. 3) of the loyalty program. In an alternative embodiment, the e-mail is sent to prospective members of the loyalty program.

As illustrated, FIG. 3 may be used as a template for e-mail communications. For example, the information printed between ‘<’ and ‘>’ may change depending on the instance of the email to the member (this does not limit other wording and information changing between communications as well). For example, social network variable 302 may be defined according to which social network platform the member has an active account with. As the member may have accounts with multiple social networks, multiple communications may be sent to the member, one for each social network. Account name variable 304 may be defined according to the name of the sponsor application associated with social network variable 302. Thus, the loyalty integration service may have different names for the sponsor application on each social network. Other marketing information 306 may be defined according to other information the loyalty platform wants to include in communications with its members.

FIG. 3 further includes link variable 308. In various embodiments, the link is encoded with the member's loyalty identification number. When the communication 300 is sent to prospective customers the link is encoded with a lead identification number. In an embodiment, the link is also encoded with an identification of the loyalty program with respect to the LIS. For example, an encoded exemplary user specific link may be as follows:

http://genericsocialplatform.com/application/invitation.html?member_ID=1234&loy_ID=1

where member_ID represents the identifier the loyalty platform has given the member and loy_ID represents the identifier the LIS has given the loyalty platform. In an embodiment, the LIS communicates (transmits electronically, verbally, etc) the loyalty identifier to the loyalty platform before the communication to the member is generated. In various embodiments, the information encoded in the URL is encrypted.

Referring back to FIG. 2, at block 204, the user (in the present example the member of the loyalty platform) clicks on the user specific link. In an embodiment, the user uses an input device on a user terminal such as a cursor to click on the link. In other embodiments, user input may include a touch interface, gesture interface, or voice interface to activate the user specific link. Upon activation a request is transmitted from the user terminal to a server associated with the link. For example, the server may be associated with a social platform.

In various embodiments, social platforms allow companies to have applications that provide user interfaces to users of the social platform. Thus, information presented at an application page of social platform may include elements served from the social platform as well as servers associates with the application (e.g., the loyalty integration services).

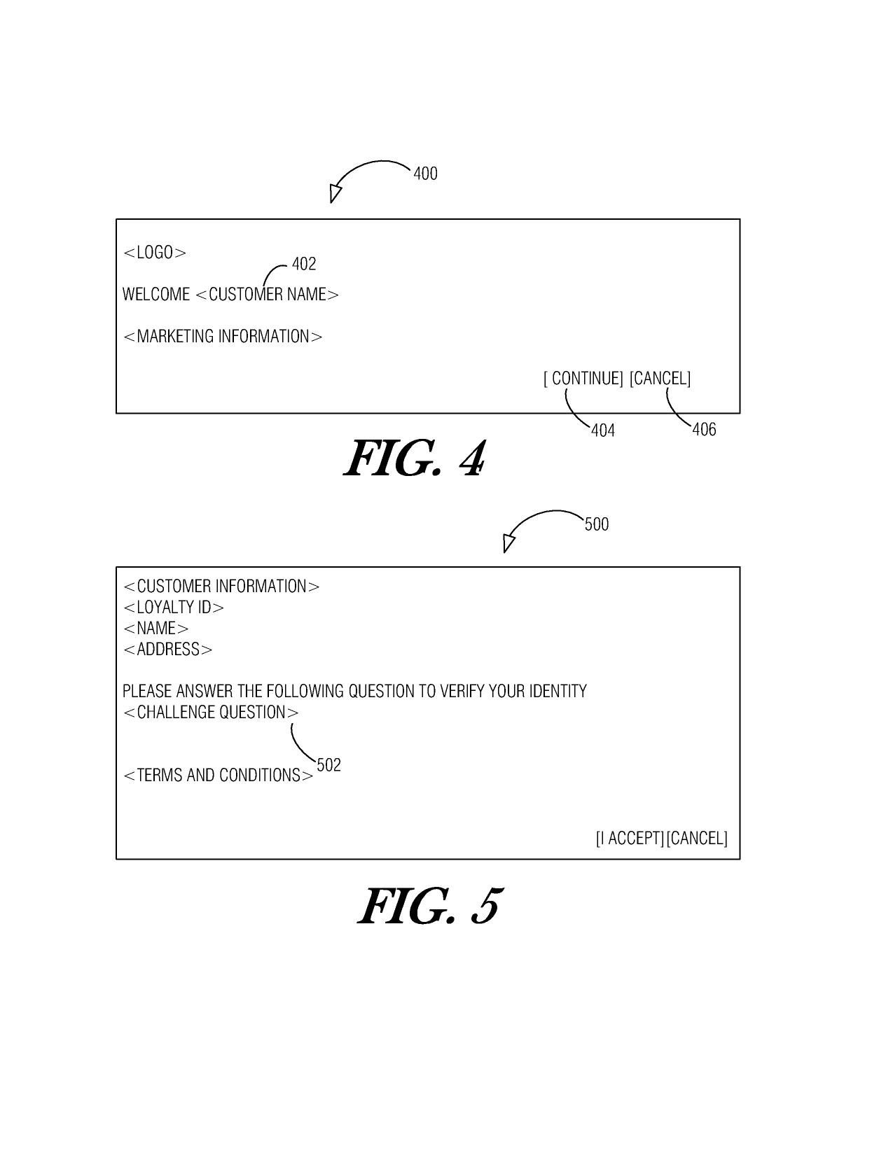

In an embodiment, at block 206, a splash (e.g., welcome) screen is presented to the user. The information on the screen may be transmitted from one or more web application servers back to the user terminal that initiated the request (e.g., at block 204). FIG. 4 illustrates an example user interface 400 that may be presented to the user on the user terminal. Shown are logo, customer name 402, and marketing information variables. Also shown are user interface input elements 404 and 406.

Customer name variable 402 may be defined and presented according to the name associated with the encoded member loyalty identification and loyalty program identification. For example LIS may store loyalty information in a database (e.g., database software and data storage 134 of FIG. 1). The loyalty information may store names associated with member identifications or lead identifications for each loyalty program. Thus, LIS may query the database using the loyalty program identification to find the member information for that particular loyalty program and then use the encoded member identification as an index to determine the customer's name. In an embodiment, the LIS requests the customer's name on-the-fly from a server associated with the loyalty program. The marketing information variable may information relating how the LIS program works. More specifically it may explain the process of signing up for the service as well as installing the LIS User Application. If the communication was sent to a potential member, the user may be asked to register with the loyalty platform as a member.

Upon selection, using an input device of a user terminal, of user interface element 404 indicating the user wishes to continue, at block 406 a further user interface is presented to the user with identifiable information from the loyalty program and a form to confirm the identity of the user. FIG. 5 is an example user interface 500 showing customer information, loyalty id, name, address variables, challenge question 502, and terms and conditions variables. As with respect to customer name variable 402 in FIG. 4, the LIS may gather the information for the variables using a combination information stored in the loyalty information database or requesting the information from the loyalty program. In this manner, the user may be assured of the authenticity of the request to answer the challenge question.

In an embodiment, challenge question variable 502 is used to verify that the user who clicked on the user specific link is the member of the loyalty program that the communication was sent to. The challenge question may be a security question that the user has previously entered an answer for with the loyalty program (e.g., mother's maiden name).

Referring back to FIG. 2, at block 210, the user confirms his or her identity. The identity may be confirmed by correctly answering the challenge question and accepting presented terms and conditions. In an embodiment, at block 212 the user is presented with a user interface requesting the LIS application be granted access to the user's social information for that social platform.

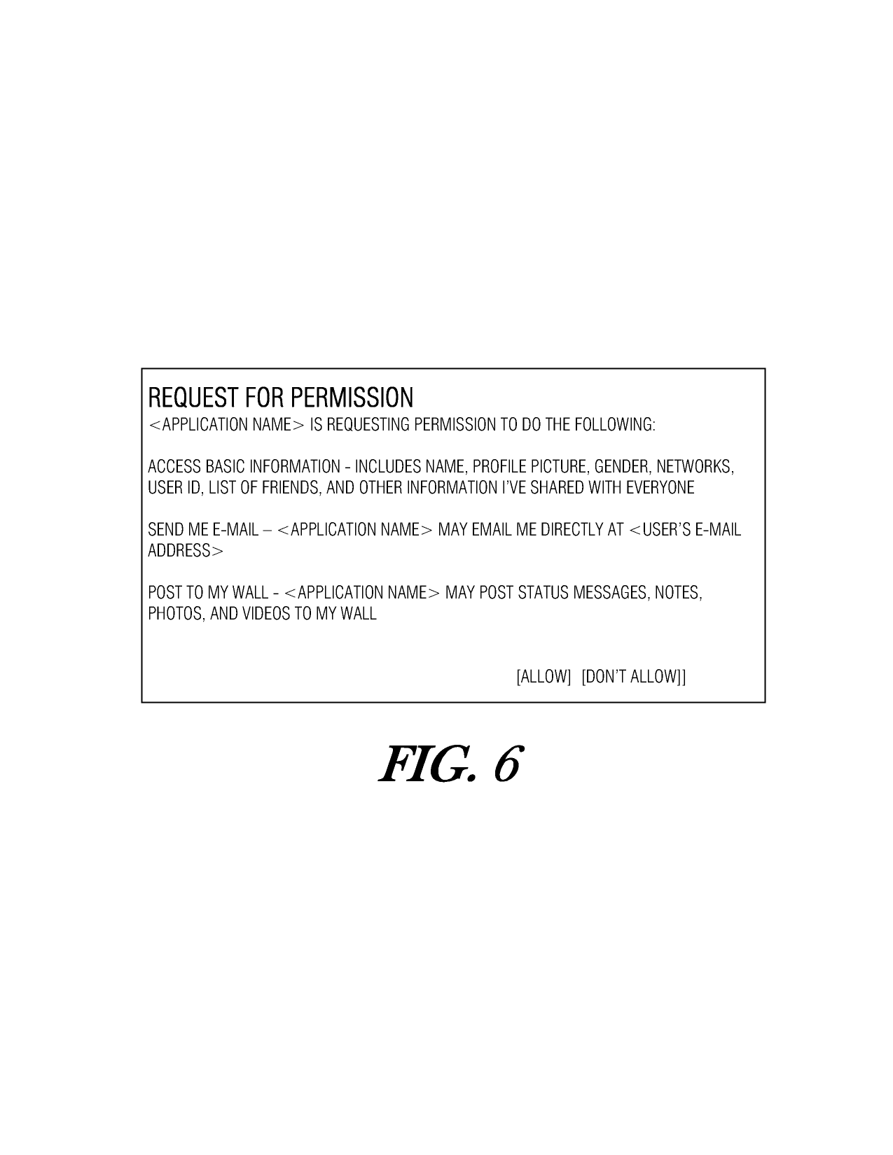

FIG. 6 is an example user interface dialog 600 that requests the user's permission to access his or her social information as well as various communications rights with the user. In various embodiments, the amount of social information requested may vary, but generally will at least include the user ID for the social platform.

Referring back to FIG. 2, at block 214 in an embodiment, the user grants access to the LIS User Application. Because the user has granted the LIS User Application access to the user ID (as it relates to the social platform) of the user and the member ID was encoded in the URL, the LIS may now make a connection between the member ID of the user for a loyalty program with the user ID of the social platform. In an embodiment, this connection is stored as an association in one or more databases of the LIS. For example, a table may exist that is indexed by user ID with columns for each loyalty program (e.g., user ID, loy_ID 1, loy_ID 2, loy_ID N). Thus, assuming the user ID was “334256” and the user arrived using the example link above, an entry in this table may look like [334256, 1234] as the member ID for loy_ID 1 was encoded as “1234.”

In an embodiment, at block 216 the LIS User Application presents the user with a user dashboard. The dashboard may show loyalty information and offers customized for the user based on the user's social data and loyalty data.

The operations described with respect to FIG. 2 may be implemented using one or more modules. For example, a system may include a communications module, an encoding module, a linking module, and a presentation module. The communications module may be responsible for blocks 202 and 204, the encoding module responsible for encoding the link, the presentation module for blocks 206, 208, and 216, and the linking module for block 214 and linking the user's account identifier with the encoded loyalty identifier. These modules are exemplary in nature and more or less modules may be used to implement the features illustrated in FIG. 2. Similarly, the distribution of tasks between the modules may be change according to various embodiments.

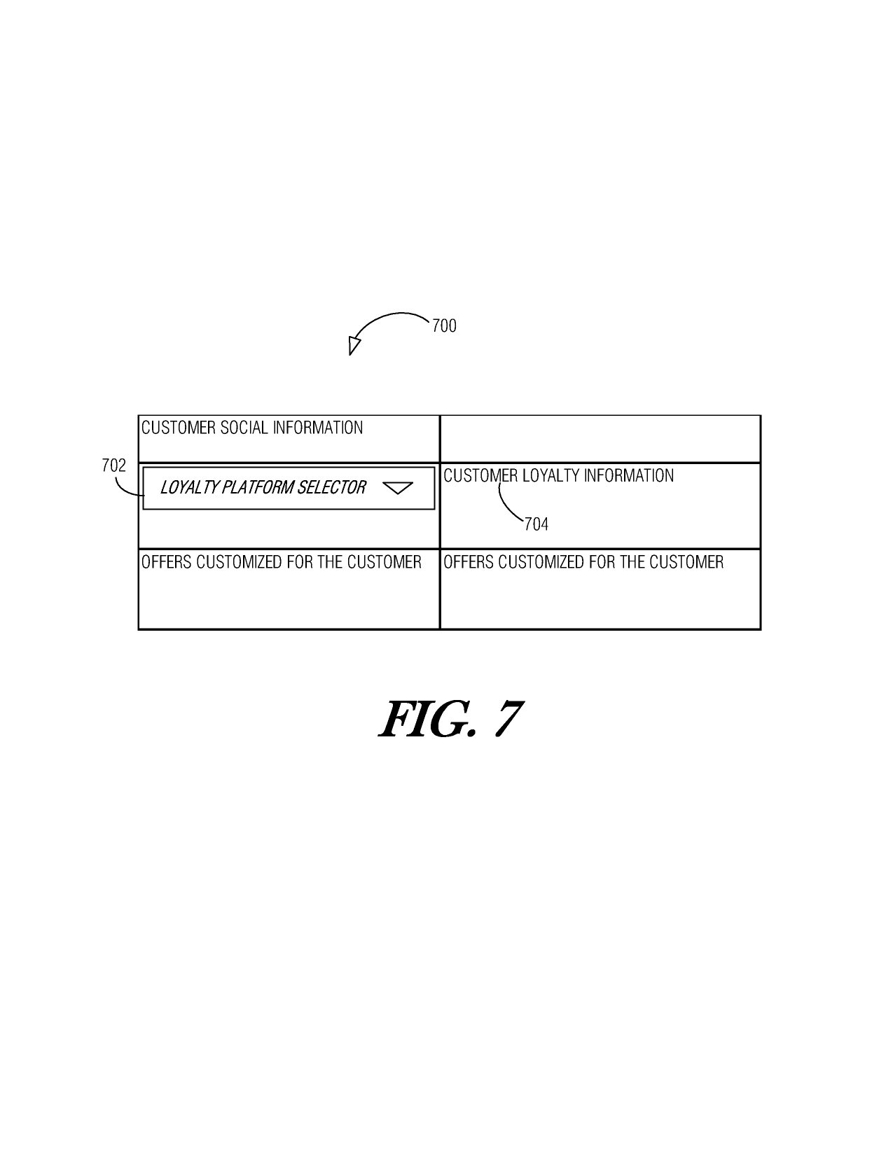

FIG. 7 is an example dashboard interface 700 that may be presented to the user. Illustrated is drop-down menu 702 in which a user input device may interact to select a loyalty program. Other selection user interface elements may be used as well instead of a drop-down menu (e.g., radio boxes, etc). The available loyalty programs may be those loyalty programs that the user has activated using a provided URL (e.g., blocks 202-210). Upon selection of a loyalty program, the offers presented in the dashboard may update according to the loyalty program selected. Customer loyalty information 704 may present loyalty program specific information about the user. For example, loyalty information 704 may include the point total for the user with respect to the selected loyalty program. The program specific information may be retrieved from the LIS directly, from a request to the loyalty program via the LIS, or from the loyalty program directly.

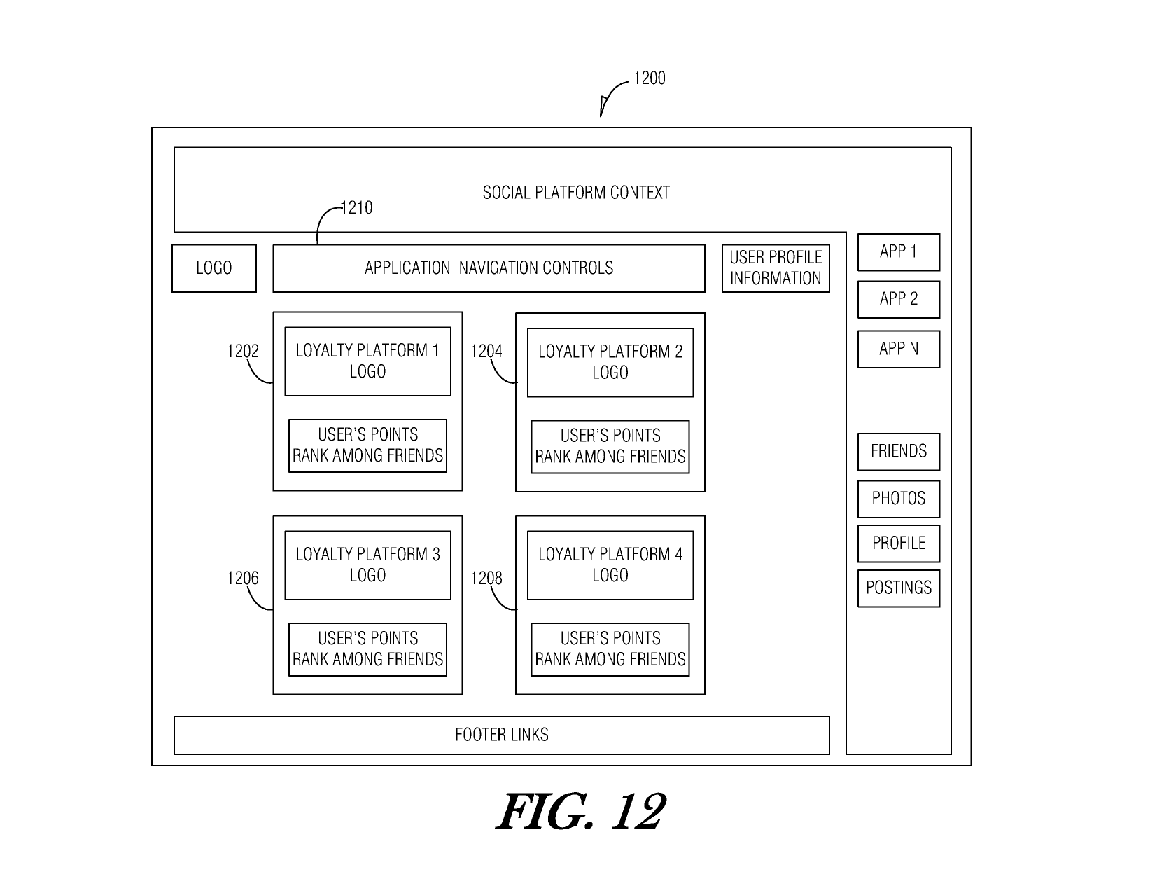

FIG. 12 illustrates an application interface 1200 within a Social Networking Platform. Application interface 1200 may be for LIS User Application. Illustrated are elements that may be common with other interfaces of the Social Networking Platform. For example, Social Platform Context may comprise links to the user's friends, photos, and postings as they used in FIG. 11. The layout, size, shape, etc, of user interface elements illustrated in FIG. 12 are exemplary in nature and other layouts of user interface elements may also be used.

Shown in FIG. 12 are loyalty information boxes 1202, 1204, 1206, and 1210. The loyalty information boxes may include information related to each loyalty platform the user has linked with the Social Networking Platform. Logos may be shown in the loyalty boxes to help the user distinguish between the loyalty programs. Also illustrated is a an information box that includes the point ranking among the user's friends. Other information may also be presented to the user such as recent purchases made by the user's friends.

The information displayed may be retrieved and processed via the LIS. For example, example, consider loyalty box 1202. To determine the user's point ranking for a loyalty provider among the user's friends a multi-step process may be used. First, User IDs of the user's friends may be retrieved by the LIS (e.g., by accessing social data of the friends) who have granted access rights to the LIS user application. Next, the User IDs may be transmitted to the LIS. The LIS may then construct a query using the User IDs to retrieve the member IDs for the user's friends for the loyalty platform. Then, a request may be transmitted to the loyalty platform to retrieve the point totals for the user's friends. In an embodiment, the point totals are maintained (e.g., stored or managed) at the LIS and thus the request need not be made. The LIS may then determine a ranking of the user with respect to the user's friends in relationship to the point totals. Finally, this information may be transmitted to the social platform for display. In various embodiments, some or all of the steps are performed on the social platform. Similar processes may be used to display other information to the user such as items, but not limited to, recently purchased by the user's friends, the user's point total, or the last purchase of the user.

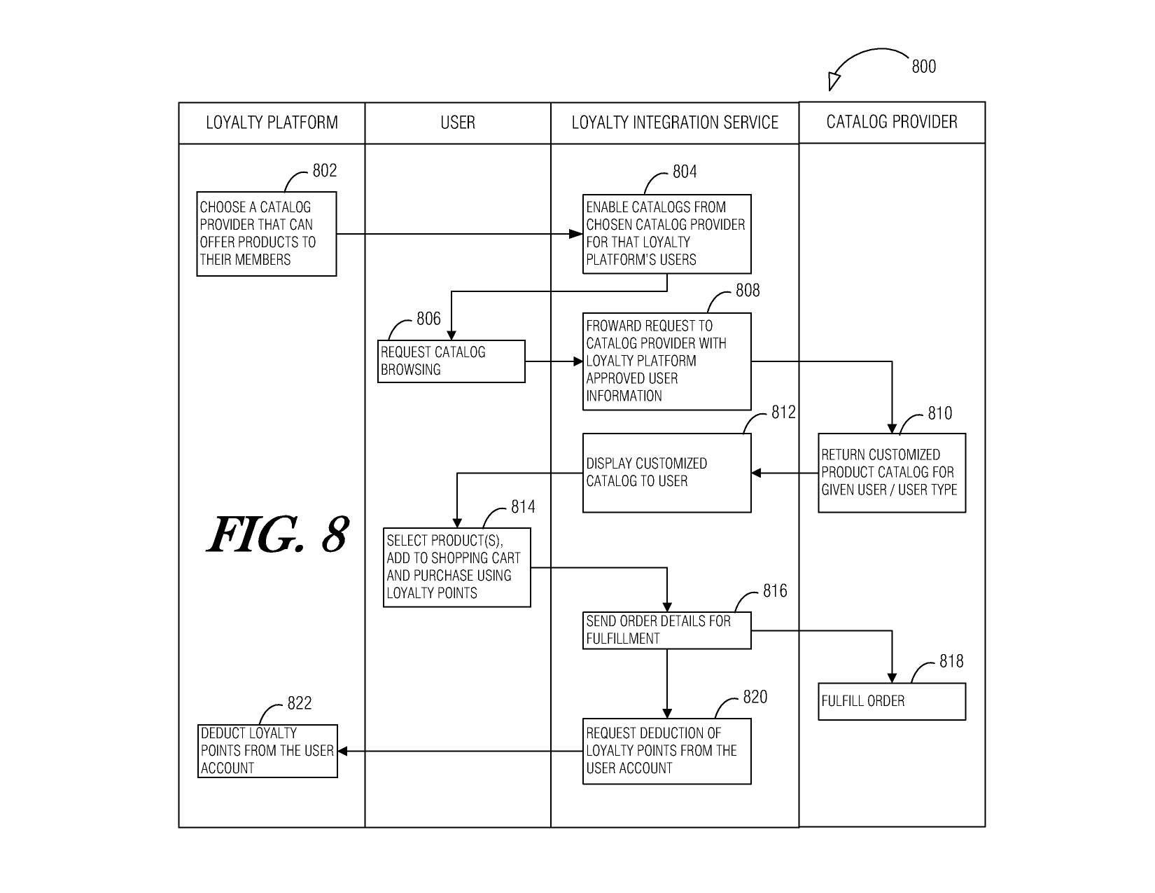

In an embodiment, FIG. 8 is data flow diagram 800 illustrating interactions between a loyalty platform, a user, a loyalty integration service, and a catalog provider. The interactions illustrated showed example method by which users may redeem their loyalty points for products listed in the catalog.

At block 802, a loyalty platform administrator (e.g., a person associated with managing the loyalty platform) chooses one or more catalog providers that may offer products to the loyalty platforms members. In an embodiment, the loyalty platform administrator uses an interface provided by the loyalty integration service to choose the catalog providers. Catalog providers provide one or more catalogs of goods that may be purchased by users. These goods may be digital or physical goods.

At block 804, in an embodiment, the loyalty integration service enables the chosen catalogs for the loyalty platform's members. For example, there may be catalogs that one loyalty platform uses which are not allowed by another loyalty platform. The loyalty integration service may store information representing that enabled catalogs for each loyalty platform. For example, each catalog and catalog provider may have an identifier. When a loyalty platform administrator indicates it is acceptable for a catalog to be used with its members, an association may be stored linking the id of the catalog with the id of the loyalty platform. If the loyalty platform indicates a catalog is no longer acceptable, the association may be removed.

At block 806, in an embodiment the user requests a catalog for browsing. This may be done for example, through the LIS User Application. At block 808, the loyalty integration service forwards the request to the catalog provider along with loyalty platform approved user information. For example, each loyalty platform may decide which information is made available to the catalog providers in much the same way as a user may decide which information is shared with various connections made on a social platform.

At block 810, in an embodiment, the catalog provider returns (e.g., through one or more servers) customized product catalogs for the given user and user type. For example, the catalog provider may use a combination of the social information the user has already allowed the LIS User Application access to along with the loyalty information made available by the loyalty platform to determine which goods to return to the user.

At block 812, in an embodiment, the loyalty integration service displays the customized catalog to the user. This may be done through the LIS User Application or LIS sponsor application. At block 814, in an embodiment, the user selects one or more products add them to a shopping cart and begins the purchase process using loyalty points of the loyalty platform. In an embodiment, credits/points of the social networking platform may be used in place of or augment loyalty points. At block 816, in an embodiment the LIS sends order details for fulfillment to the catalog provider upon which, at block 818, the catalog provider may fulfill the order for the goods in the shopping cart.

At block 820, the LIS requests deductions of loyalty points from the user account with respect to the loyalty platform. If social networking credits are used, deductions are made with respect to the balance of the social networking platform credits. At block 822, in an embodiment, the request for deduction is transmitted to the loyalty platform to deduct the loyalty points from the user account. In various embodiments, the LIS manages point totals for the loyalty platform whereby there is no need to communicate to the loyalty platform the request for deduction of loyalty points.

As with FIG. 2, the operations described with respect to FIG. 8 may be implemented using one or more modules. For example, a system may include a catalog module, a linking module, an offer module, and a fulfillment module. The catalog module may be responsible implementing functionality associated with blocks 802 and 808, the linking module responsible for block 804, the offer module for blocks 812 and 814, and the fulfillment module for blocks 816 and 820. These modules are exemplary in nature and more or less modules may be used to implement the features illustrated in FIG. 8. Similarly, the distribution of tasks between the modules may be change according to various embodiments.

In an embodiment, the loyalty integration service provides additional features such as customizing the loyalty platforms sponsor page on a social platform. As illustrated in FIG. 1, there is an LIS sponsor application. Because this sponsor application communicates with the LIS it also aware of a user's ID for the social platform. Thus, when a user visits the sponsors page on the social platform customized offers may be presented to the user based on the user's social and loyalty data. In an embodiment, the user is able to exchange loyalty points for a currency used by the social platform using the LIS User Application (e.g., FACEBOOK credits). Each loyalty platform may set an exchange rate to use for the conversion.

FIG. 14 illustrates an example LIS sponsor application user interface 1400 that may be presented to a user upon visiting a business's presence on a Social Networking Platform. Illustrated are elements that may be common with other interfaces of the Social Networking Platform. For example, Social Platform Context may comprise links to the user's friends, photos, and postings as they used in FIG. 11. The layout, size, shape, etc, of user interface elements illustrated in FIG. 14 are exemplary in nature and other layouts of user interface elements may also be used.

Illustrated are user interface portions for suggested items 1402, items popular with your friends 1404, featured items 1406, catalog search 1408, and custom offer banners 1410.

Information that is displayed in the suggested items 1402 portion of interface 1400 may include displaying one or more items from the item catalog that the business, LIS, or loyalty platform has chosen (e.g, by an administrator or matching algorithm). The items chosen may be based on the user's social data as well as loyalty profile of the user. For example, if an age of the user is listed in the social data, items may be shown that have been purchased by other users with the same age.

In various embodiments, displaying items means displaying textual or graphical information that represent the item. For example, if the item is a book, a picture of the book cover, the title of the book, and price of the book may be displayed. A description of the item may be also be presented as part of displaying the item. Additionally, an interface element (e.g., link) that when activated allows the user to purchase the item.

Information that is displayed in the items popular with your friends 1404 portion of interface 1400 may include one or more items that have recently (e.g., currently or within the past day, week, etc) been viewed or purchased by the user's friends. For example User IDs of the user's friends may be retrieved by the LIS (e.g., by accessing social data of the friends) who have granted access rights to the LIS user application. Next, the User IDs may be transmitted to the LIS. The LIS may then construct a query using the User IDs to retrieve the recently viewed or purchased items of the user's friends. This information may be stored, for example, in a database of the LIS that keeps track of user actions (purchases, views) in either the LIS user application or LIS sponsor application. Finally, this information may be transmitted to the social platform for display. In various embodiments, some or all of the steps are performed on the social platform.

Featured items 1406 may include items chosen by the business, LIS, or loyalty platform, for display to the user.

Catalog search 1408 may enable the user to search for items in the catalogs approved by the loyalty platform. For example, an input box may be presented to the user in which the user enters one or more keyword to search for. The keywords may be transmitted to the LIS where they are used to formulate a query to search through the items in the approved catalogs. In various embodiments, the keywords are transmitted to a catalog provider to formulate and run the query. The items results, from either the LIS or catalog provider, are transmitted back to the social platform where they may be displayed to the user in catalog search 1408. The user may then purchase one or more the items in the result as described in FIG. 8 (e.g., FIG. 8 elements 814-822).

Custom offer 1410 may display one or more custom offer banners (textual or graphical information) to a user upon visiting the business's presence on the social networking platform. For example, the custom offer banner may include the name of the user visiting as well as display one or more items to the user for purchase.

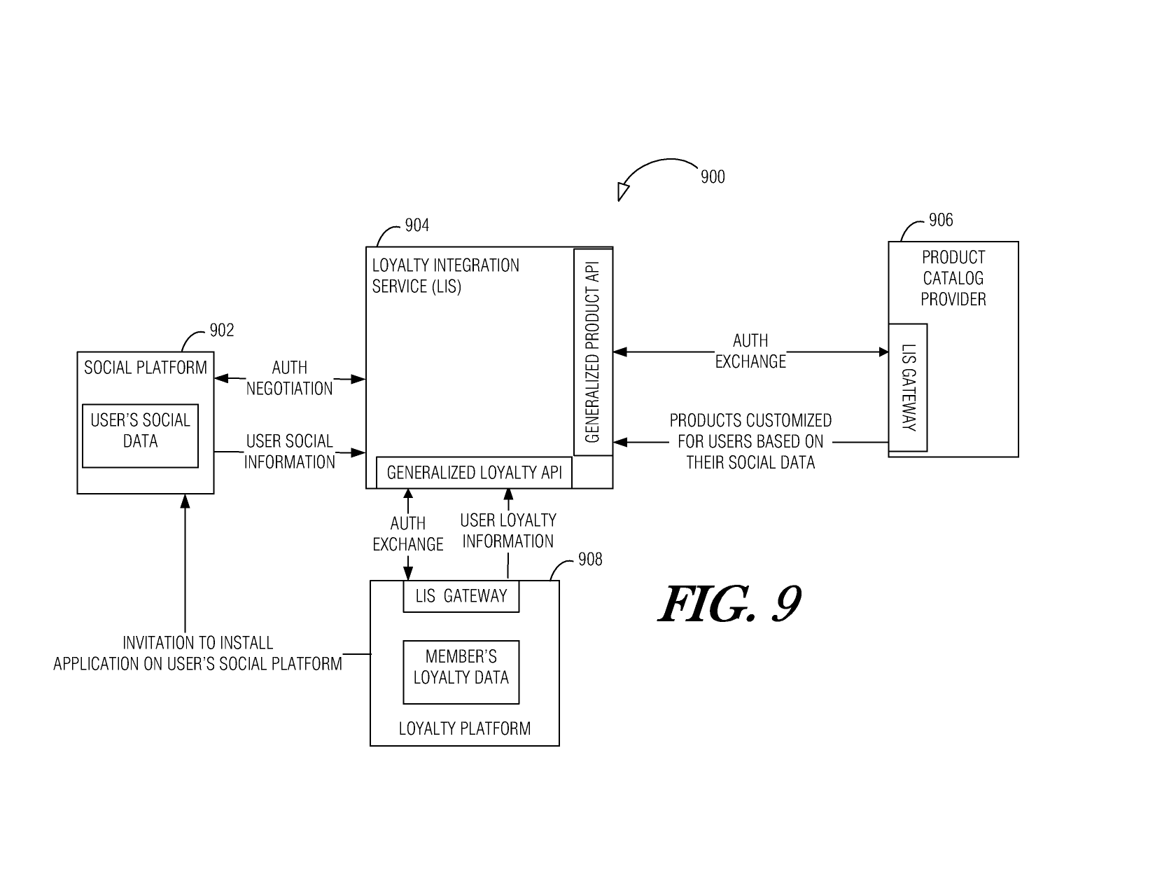

FIG. 9 illustrates a system overview 900 of the exchange of information between various components. Illustrated is social platform 902, loyalty integration service 904, product catalog provider 906, and loyalty platform 908. As illustrated, there is authorization negotiation between LIS 904 and social platform 902 in which the user social information is sent to LIS 904. Similarly there is an authorization exchange between LIS 904 and loyalty platform 908 in which user loyalty information is transmitted to LIS 904 from loyalty platform 908. Additionally, there is an authorization exchange between product catalog provider 906 and LIS 904 in which information concerning products customized for users based on their social data is transmitted to LIS 904. Lastly illustrated is the exchange between loyalty platform 908 for the invitation to install an application on social platform 902 for a user.

Information exchanged between the components depicted in FIG. 9 may be completed using one or more Application Program Interfaces (APIs). In various embodiments, an API is a functional interface that serves to allow the exchange of information between programs and system. For example, consider the example discussed at block 820 FIG. 8 in which LIS requests deduction of loyalty points from a user account at a loyalty platform. Loyalty Platform may have an API with a function “deduct_points (int user ID, int points).” Here, the function is called deduct_points and takes integer User ID and integer points as inputs. Thus, LIS may establish a connection with the loyalty platform and call deduct_points (12345, 50) to deduct 50 points from the user associated with user ID 12345.

In various embodiments, the API returns information to the calling component. For example, the loyalty platform may return “true” if the deduction was successful or “false” indicating the deduction was unsuccessful. In various embodiments, the API is used to retrieve information but perform no operation. For example, consider block 810 in which a catalog provider returns product catalog. The catalog provider may have a function “get_catalog(int catalog id)” which returns a catalog object (e.g., data representing a catalog of items including descriptions and pricing).

In an embodiment, the LIS also provides a configuration interface to administrators of the loyalty platforms to create offers (e.g., custom offers 1410). This configuration interface may be the LIS sponsor application or a webpage served from the LIS. As both the LIS sponsor application and webpage access the same database information, one or both of the interfaces may be used. The configuration interface may be used to enable or disable certain catalog providers. More details may also be configured such as which types of products are allowed as well as which types of users (e.g., organized according to demographic, social, and loyalty information) see which types of products. Another configuration parameter may be how many points each type of good costs keeping in mind that different types of users may be presented with different prices for the goods.

In an embodiment, the LIS also provides reports to administrators of loyalty platforms related to the social information of their members. Below is example information that may be included in these reports:

1. Story popularity summary reports
a. Filters
   i. Story category—All/select one or more
   ii. Story—All/select one or more
   iii. Date range—start and end dates/last 30/60/90 days
b. Show following attributes in table
   i. Story Title
   ii. Story Type
   iii. Location—Page Dashboard/canvas page/Feed
   iv. Number of Views
   v. Number of Views because friend relations
   vi. Number of Clicks
   vii. Number of Clicks because friend relations
   viii. Number of clicks on ‘Call For Action’
   ix. Number of clicks on ‘Call For Action’ because friend relations
c. Trend graphs—For up to 5 categories show line graphs of overall views/clicks/call for actions v/s and friend influenced numbers, over period of date range

2. Story level analytics
a. Filters
   i. Date range—start and end dates/last 30/60/90 days
b. Show following attributes in table
   i. Location—Page Dashboard/canvas page/Feed
   ii. Number of Views
   iii. Number of Views because friend relations
   iv. Number of Clicks
   v. Number of Clicks because friend relations
   vi. Number of clicks on ‘Call For Action’
   vii. Number of clicks on ‘Call For Action’ because friend relations
3. How is your program doing against other programs in same category. As LIS has data for other Loyalty Platforms, the LIS can hide all the identifiable data from Loyalty Platforms in similar categories and present it to a Loyalty Platforms in summary format for comparison.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

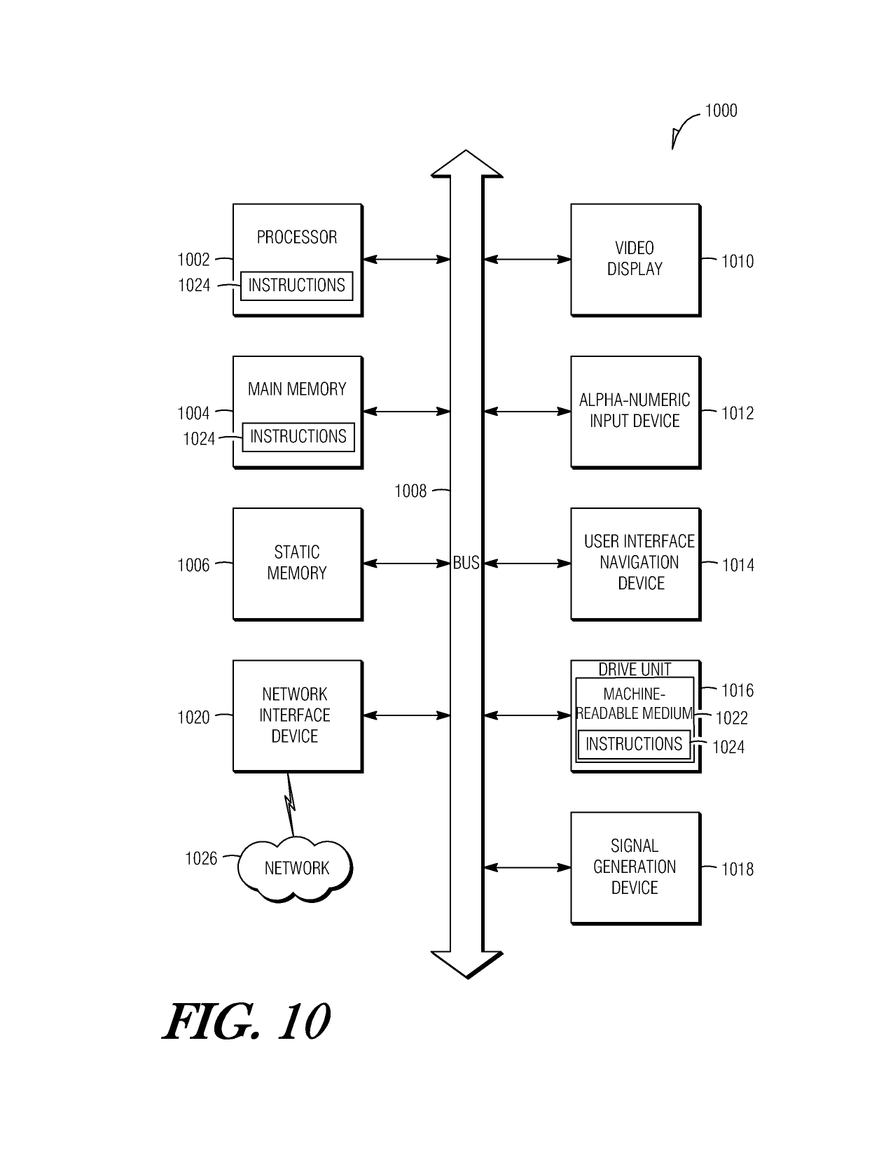

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method to authorize a loyalty integration service with a social platform, the method comprising:
transmitting an authorization screen to a user terminal, the authorization screen including a request to grant a loyalty integration service (LIS) user application access to an identifier of a user on a social platform;
receiving authorization from the user indicating the LIS user application can access the identifier of the user;
based on receiving the authorization, linking the identification of the user on the social platform with a member identifier associated with the user on a loyalty program; and
presenting on the user terminal, within the LIS user application, a dashboard to the user, the dashboard including offers customized for the user based on the user's social data in the social network and loyalty data in the loyalty program.

2. The method of claim 1, further comprising:
transmitting a user interface for display to the user terminal before presenting the authorization screen, the user interface including a challenge question for verifying a user's identity; and
receiving a response from the user terminal with an answer to the challenge question.

3. The method of claim 1, further comprising:
transmitting a communication message to a user, the communication including a the link, which when activated, presents the authorization screen to the user.

4. The method of claim 3, wherein the link is encoded with the member identifier.

5. The method of claim 3, wherein linking the identification of the user on the social platform with a member identifier associated with the user on a loyalty program link comprises:
determining the member identification by retrieving it from the link.

6. The method of claim 1, wherein the LIS user application is at least partially hosted from the social platform.

7. The method of claim 1, wherein the dashboard presents a point total of the user with respect to the loyalty program.

8. A non-transitory computer-readable medium comprising instructions, which when executed by at least one processor, cause the at least one processor to perform a method, the method comprising:
transmitting an authorization screen to a user terminal, the authorization screen including a request to grant a loyalty integration service (LIS) user application access to an identifier of a user on a social platform;
receiving authorization from the user indicating the LIS user application can access the identifier of the user;
based on receiving the authorization, linking the identification of the user on the social platform with a member identifier associated with the user on a loyalty program; and
presenting on the user terminal, within the LIS user application, a dashboard to the user, the dashboard including offers customized for the user based on the user's social data in the social network and loyalty data in the loyalty program.

9. The non-transitory computer-readable medium of claim 8, the method further comprising:
transmitting a user interface for display to the user terminal before presenting the authorization screen, the user interface including a challenge question for verifying a user's identity; and
receiving a response from the user terminal with an answer to the challenge question.

10. The non-transitory computer-readable medium of claim 8, the method further comprising:
transmitting a communication message to a user, the communication including a the link, which when activated, presents the authorization screen to the user.

11. The non-transitory computer-readable medium of claim 10, wherein the link is encoded with the member identifier.

12. The non-transitory computer-readable medium of claim 10, wherein linking the identification of the user on the social platform with a member identifier associated with the user on a loyalty program link comprises determining the member identification by retrieving it from the link.

13. The non-transitory computer-readable medium of claim 8, wherein dashboard presents a point total of the user with respect to the loyalty program.

14. The non-transitory computer-readable medium of claim 8, wherein the LIS user application is at least partially hosted from the social platform.

15. A system comprising:
a presentation module configured to:
transmit an authorization screen to a user terminal, the authorization screen including a request to grant a loyalty integration service (LIS) user application access to an identifier of a user on a social platform;
receive authorization from the user indicating the LIS user application can access the identifier of the user;
a linking module configured to, based on receiving the authorization, link the identification of the user on the social platform with a member identifier associated with the user on a loyalty program; and
wherein the presentation module is further configured to present on the user terminal, within the LIS user application, a dashboard to the user, the dashboard including offers customized for the user based on the user's social data in the social network and loyalty data in the loyalty program.

16. The system of claim 15, further comprising a communications module configured to transmit a communication message to a user, the communication including a the link, which when activated, presents the authorization screen to the user.

17. The system of claim 16, further comprising an encoding module configured to encode the link with the member identifier.

18. The system of claim 17, wherein the encoding module is configured to encode the link with an identifier of the loyalty program.

19. The system of claim 15, wherein the LIS user application is at least partially hosted from the social platform.

20. The system of claim 15, wherein the dashboard presents a point total of the user with respect to the loyalty program.
